(19) United States
(12) Patent Application Publication
(10) Pub. No.: US 2024/0194116 A1
(43) Pub. Date: Jun. 13, 2024

(54) DISPLAY DEVICE AND A PLURALITY OF DRIVING CHIP THEREIN

(71) Applicant: TCL CHINA STAR OPPOELECTRONICS TECHNOLOGY CO., LTD., Shenzhen (CN)

(72) Inventor: Qingsheng LAN, Shenzhen (CN)

(73) Assignee: TCL CHINA STAR OPTOELECTRONICS TECHNOLOGY CO., LTD., Shenzhen (CN)

(21) Appl. No.: 18/175,539

(22) Filed: Feb. 28, 2023

(30) Foreign Application Priority Data
Dec. 9, 2022 (CN) 202211589474.5

(51) Int. Cl. G09G 3/20

(52) U.S. Cl. CPC G09G 3/2096; G09G 2310/0264; G09G 2370/00

(57) ABSTRACT

A display device is provided. The display device includes a timing controller and a plurality of driver chips. The timing controller is configured to output display data. The driver chips include a plurality of first driver chips and a plurality of second driver chips. At least a part of the second driver chips are electrically connected to the first driver chips. Each of the first driver chips is electrically connected to the timing controller and a corresponding one of the second driver chip. Each of the first driver chips is configured to receive the display data, amplify the display data, and transmit the amplified display data to the corresponding one of the second driver chips. The loss of the display data transmitted to the second driver chips due to the long transmission lines can be reduced, thereby improving the display effect.

### TECHNICAL FIELD

The present disclosure relates to the technology field of display, and more particularly to a display device.

### BACKGROUND

Currently, display panels are developing towards large sizes and high resolution. As sizes of the display panels become larger and larger, sizes of display devices also become longer. There are also new challenges in accurately transmitting display data on the longer display devices.

An existing timing controller converts display data into converted display data after internal processing and outputs the converted display data to a driver chip. The display data has transmission loss in a transmission channel. As a size of a display device becomes longer, a transmission link of the display data becomes longer. Accordingly, the loss of the display data in the transmission channel also increases, so that the driver chip cannot accurately receive information of the display data transmitted by the timing controller.

In summary, improving the signal transmission loss caused by the long transmission link of the display data is an urgent problem to be solved.

### SUMMARY OF DISCLOSURE

Embodiments of the present disclosure provide a display device capable of reducing transmission loss of display data to improve display effect.

In an aspect, an embodiment of the present disclosure provides a display device including a timing controller and a plurality of driver chips. The timing controller is configured to output display data. The driver chips include a plurality of first driver chips and a plurality of second driver chips, and at least a part of the second driver chips are electrically connected to the first driver chips. Each of the first driver chips is electrically connected to the timing controller and a corresponding one of the second driver chip, each of the first driver chips is configured to receive the display data, amplify the display data, and transmit the amplified display data to the corresponding one of the second driver chips.

Optionally, in some embodiments of the present disclosure, the first driver chips are further configured to receive the display data, process the display data, and output data voltages.

Optionally, in some embodiments of the present disclosure, each of the first driver chips includes a first control module and a second control module. The first control module is configured to receive the display data, process the display data, and output the data voltage. The second control module includes a receiving module, an amplifying module, and an output module. The receiving module is configured to receive the display data, process the display data, and output the processed display data to the amplifying module. The amplifying module is configured to amplify the processed display data and output the amplified display data to the output module. The output module is configured to perform an output process on the amplified display data and output the outputted display data to the corresponding one of the second driver chips.

Optionally, in some embodiments of the present disclosure, the second control module includes a receiving module, an amplifying module, and an output module. The receiving module is configured to receive the display data, process the display data, and output the data voltage. The receiving module is further configured to receive the display data, process the display data, and output the processed display data to the amplifying module. The amplifying module is configured to amplify the processed display data and output the amplified display data to the output module. The output module is configured to perform an output process on the amplified display data and output the outputted display data to the corresponding one of the second driver chips.

Optionally, in some embodiments of the present disclosure, each of the first driver chips is electrically connected to one of the second driver chips.

Optionally, in some embodiments of the present disclosure, at least a part of the first driver chips are respectively electrically connected to at least two of the second driver chips.

Optionally, in some embodiments of the present disclosure, at least a part of the second driver chip are electrically connected to the timing controller, the second driver chips electrically connected to the timing controller are disposed close to the timing controller, and the second driver chips electrically connected to the first driver chips are disposed away from the timing controller.

Optionally, in some embodiments of the present disclosure, multiple of the first driver chips are arranged close to the timing controller, and multiple of the second driver chips are arranged away from the timing controller.

Optionally, in some embodiments of the present disclosure, a number of the first driver chips is equal to a number of the second driver chips.

Optionally, in some embodiments of the present disclosure, at least one of the second driver chips includes a receiving module, an amplifying module, and an output module. The receiving module is configured to receive display data, process the display data, and output the processed display data to the amplifying module. The amplifying module is configured to amplify the processed display data and output the amplified display data to the output module. The output module is configured to perform an output process on the amplified display data and output a data voltage.

The embodiments of the present disclosure provide a display device. The display device includes a timing controller and a plurality of driver chips. The timing controller is configured to output display data. The driver chips include a plurality of first driver chips and a plurality of second driver chips, and at least a part of the second driver chips are electrically connected to the first driver chips. Each of the first driver chips is electrically connected to the timing controller and a corresponding one of the second driver chip, each of the first driver chips is configured to receive the display data, amplify the display data, and transmit the amplified display data to the corresponding one of the second driver chips. In the display device, the first driver chips are arranged to reduce the loss of the display data transmitted to the second driver chips due to the long transmission lines, thereby improving the display effect.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and those skilled in the art can still derive other drawings from these accompanying drawings without creative efforts.

FIG. 1 illustrates a schematic structural diagram of a display device provided by a first embodiment of the present disclosure.

FIG. 2 illustrates a first schematic structural diagram of each first driver chip in the display device shown in FIG. 1.

FIG. 3 illustrates a relationship between a length of a data line and intensity of display data.

FIG. 4 illustrates a second schematic structural diagram of each first driver chip in the display device shown in FIG. 1.

FIG. 5 illustrates a schematic structural diagram of a display device provided by a second embodiment of the present disclosure.

FIG. 6 illustrates a schematic structural diagram of each first driver chips in the display device shown in FIG. 5.

FIG. 7 illustrates a schematic structural diagram of a display device provided by a third embodiment of the present disclosure.

FIG. 8 illustrates a schematic structural diagram of a display device provided by a fourth embodiment of the present disclosure.

FIG. 9 illustrates a schematic structural diagram of a second driver chip in the display device provided by an embodiment of the present disclosure.

### DETAILED DESCRIPTION OF EMBODIMENTS

To describe the technical solutions of the embodiments of the present disclosure more clearly, the following briefly introduces the accompanying drawings required for describing the embodiments. Apparently, the accompanying drawings in the following description show only some embodiments of the present disclosure, and those skilled in the art may still derive other drawings from these accompanying drawings without creative efforts.

An embodiment of the present disclosure provides a display device capable of reducing loss of display data transmitted to a second driver chip due to a long transmission line and improving display effect. Detailed descriptions are given below. It should be noted that the description sequence of the following embodiments is not intended to limit the preferred sequence of the embodiments. Furthermore, in the description of the present disclosure, the term “including” means “including but not limited to”. The terms “first”, “second”, “third” and so on are only used as labels, which are used to distinguish different objects, rather than to describe a specific order.

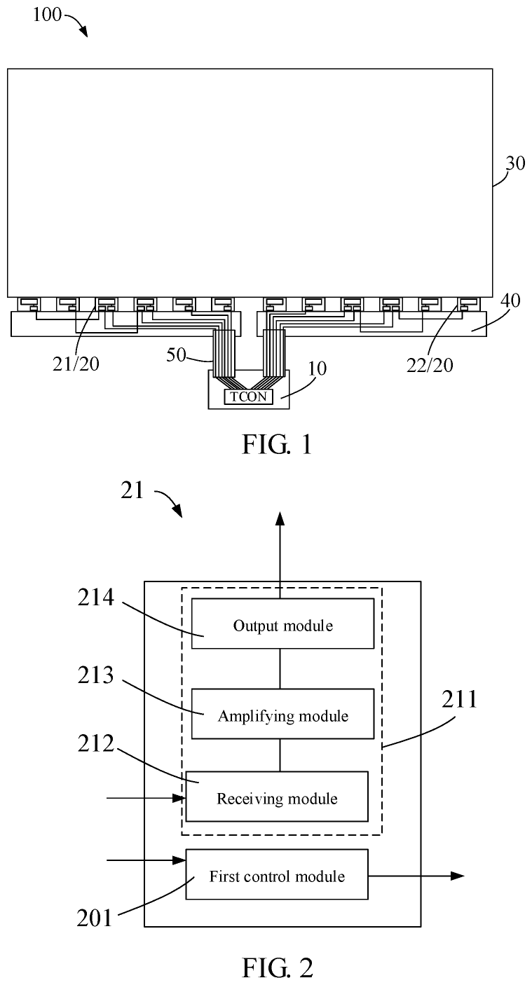

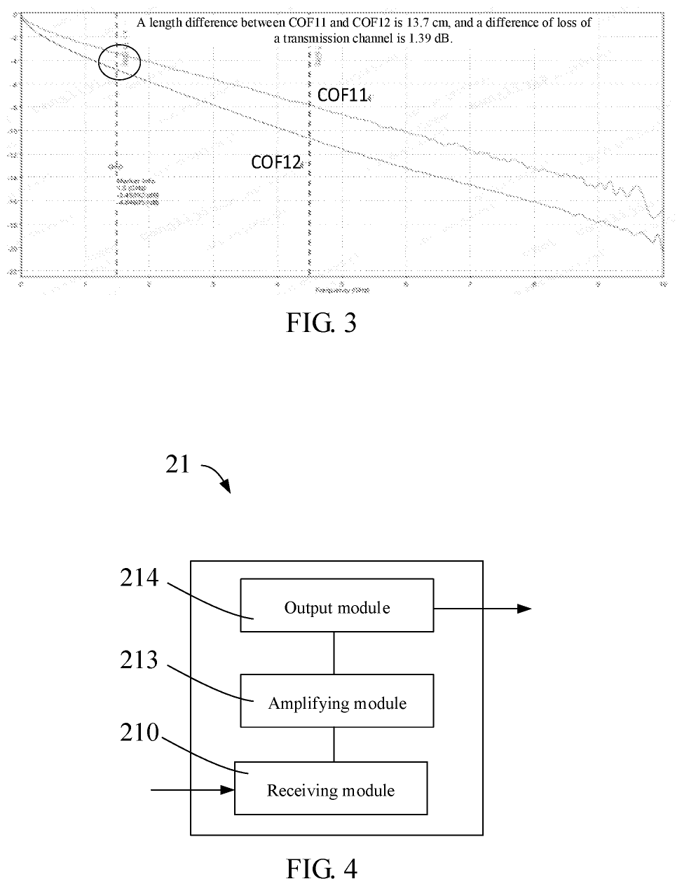

Please refer to FIG. 1 and FIG. 2. FIG. 1 illustrates a schematic structural diagram of a display device provided by a first embodiment of the present disclosure. FIG. 2 illustrates a first schematic structural diagram of each first driver chip in the display device shown in FIG. 1. FIG. 3 illustrates a relationship between a length of a data line and intensity of display data. As shown in FIG. 1, the present disclosure provides a display device 100 including a timing controller 10 and a plurality of driver chips 20. The timing controller 10 is configured to output display data. The driver chips 20 include a plurality of first driver chips 21 and a plurality of second driver chips 22. At least a part of the second driver chips 22 are electrically connected to the first driver chips 21. Each of the first driver chips 21 is electrically connected to the timing controller 10 and a corresponding one of the second driver chips 22. Each of the first driver chips 21 is configured to receive the display data, amplify the display data, and transmit the amplified display data to the corresponding one of the second driver chips 22.

In the display device 100 provided by the present disclosure, the first driver chips 21 are configured to receive the display data, amplify the display data, and transmit the amplified display data to the second driver chips 22, thereby reducing loss of the display data due to a long transmission line to improve display effect. A voltage potential of the amplified display data is greater than a voltage potential of the display data received by the first driver chips 21. That is, a voltage potential compensation is performed, by the first driver chips 21, on the display data outputted to the second driver chips 22, so that the transmission loss of the display data can be reduced to improve the display effect.

In the embodiment of the present disclosure, the first driver chips 21 are further configured to receive the display data, process the display data, and output data voltages.

In the embodiment of the present disclosure, as shown in FIG. 2, each of the first driver chips 21 includes a first control module 201 and a second control module 211. The second control module 211 includes a receiving module 212, an amplifying module 213, and an output module 214. The first control module 201 is configured to receive the display data, process the display data, and output the data voltage. The receiving module 212 is configured to receive the display data, process the display data, and output the processed display data to the amplifying module 213. The amplifying module 213 is configured to amplify the processed display data and output the amplified display data to the output module 214. The output module 214 is configured to perform an output process on the amplified display data and output the outputted display data to the corresponding one of the second driver chips 22. Further, the first control module 201 includes a signal receiving submodule and a signal processing submodule. The signal processing submodule includes a digital shifting module, a data temporary storage module, a data latch module, a voltage level converting module, a digital/analog converting module, and an operational amplifying module which are configured to process and convert the display data outputted by the signal receiving sub-module and output the data voltage.

Specifically, the first control module 201 of the first driver chip 21 is electrically connected to the timing controller 10 to receive the display data, and the receiving module 212 of the first driver chip 21 is also electrically connected to the timing controller 10 to receive the display data.

In the embodiment of the present disclosure, each of the second driver chips 22 includes a receiving module and a signal processing module. At least a part of the receiving modules of the second driver chips 22 are electrically connected to the output modules 214 of the first driver chips 21 to receive the amplified display data. Further, the receiving modules of the second driver chips 22 can also be electrically connected to the timing controller 10 to receive the display data outputted by the timing controller 10.

Specifically, each of the first driver chips 21 has two display data receiving circuits which are the first control module 201 and the receiving module 212. The first control module 201 is responsible for receiving the display data transmitted by the timing controller 10, performing data processing and conversion according to driving sequence requirements, processing and converting the display data, and outputting the data voltage. The amplifying module 213 of each of the first driver chips 21 completes the amplification of the display data for the second driver chip 22, so that the corresponding one of the second driver chips 22 can accurately receive high-speed display data. In such a design, it is beneficial for the driver chips 20 that are far from the timing controller 10 in a large-sized product to accurately receive the display data. Specifically, when the display device 100, such as a television, has different sizes, transmission lengths of the display data are different, as shown in Table 1.

TABLE 1

| Television size | 55-inch | 65-inch | 75-inch | 85-inch | 98-inch |
|---|---|---|---|---|---|
| Panel length(cm) | 121.76 | 143.90 | 166.03 | 188.16 | 216.20 |
| Signal line length(cm) | 60.88 | 71.95 | 83.02 | 94.08 | 108.10 |

In the embodiment of the present disclosure, the display device 100 further includes a display panel 30. The display panel 30 is electrically connected to the driver chips 20. In the above-mentioned large-sized display panel 30, when the size is larger, the signal lines used for transmitting the display data are long. The driver chips 20 located on both sides of the display panel 30 are farthest from the timing controller 10, so the transmission links of these drive chips 20 which receive the display data are the longest and the intensity loss of the display data is the most serious. By electrically connecting the second driver chips 22 which are far from the timing controller 10 to the first driver chips 21 which are closer to the timing controller 10, the amplification and enhancement of the display data are completed at certain positions of transmission channels by the first driver chips 21, and then the amplified and enhanced display data is outputted to the second driver chips. This is beneficial to perform middle compensation for the display data transmitted to the second driver chips 22 which are far away from the timing controller 10, so that the second driver chips 22 can accurately receive the display data.

In the embodiment of the present disclosure, the display device 100 further includes driving circuit boards 40. The driving circuit boards 40 are provided with input interfaces and output interfaces. The input interfaces are electrically connected to the timing controller 10, and the output interfaces are electrically connected to the driver chips 20. The output interfaces are arranged along a length direction of the driving circuit boards 40. The driver chips 20 are electrically connected to the corresponding output interfaces. That is, the driver chips 20 are sequentially arranged along the length direction of the driving circuit boards 40. Specifically, as shown in FIG. 1, the display device 100 can include two driving circuit boards 40. The timing controller 10 is arranged at one side of the two driving circuit boards 40 away from the driver chip 20. A central axis between the two driving circuit boards coincides with a central line of the timing controller 10. The driver chips 20 are sequentially arranged along one side of the driving circuit boards 40 away from the timing controller 10. The timing controller 10 is electrically connected to the driver chips 20 through signal lines. Accordingly, when the driver chips 20 are farther away from the central axis, distances from the timing controller 10 are farther. That is, as shown in FIG. 3, the signal lines between the driver chips 20 and the timing controller 10 used for transmitting the display data are longer. Accordingly, the transmission loss of the display data on the signal lines are greater due to the influence of the impedances of the signal lines. When the signal transmission loss is greater, the driver chips 20 cannot receive the display data accurately, thereby affecting the display effect.

In the embodiment of the present disclosure, the display device 100 further includes flexible adapter cables 50. The flexible adapter cables 50 are arranged between the timing controller 10 and the driving circuit boards 40. The display data transmitted by the timing controller 10 passes through the flexible transfer cables 50 and the driving circuit boards 40 and then is outputted to the corresponding driver chips 20. The driver chips 20 receives the display data transmitted from the timing controller 10 to complete the processing and conversion of the display data, and then outputs the data voltages to the display panel 30 through the output channels of the driver chips 20.

In the embodiment of the present disclosure, each of the first driver chips 21 is electrically connected to one of the second driver chips 22. Specifically, the first control module 201 and the receiving module 212 of each of the first driver chips 21 are electrically connected to the timing controller 10. The output modules 214 of the first driver chips 21 are electrically connected to the receiving modules of the second driver chips 22 in a one-to-one correspondence. As shown in FIG. 1, each of the first driver chips 21 is electrically connected to a receiving module of a corresponding one of the second driver chips 22. Specifically, a distance from each of the second driver chips 22 to the timing controller 10 is greater than a distance from a corresponding one of the first driver chips 21 to the timing controller 10. The receiving module of each of the second driver chips 22 is connected to the output module 214 of the corresponding one of the first driver chips 21. The middle compensation is performed for the display data transmitted to the second driver chips 22 by the first driver chips 21. This is beneficial for the second driver chips 22 to receive the display data accurately.

In the embodiment of the present disclosure, at least a part of the second driver chip 22 are electrically connected to the timing controller 10. The second driver chips 22 electrically connected to the timing controller 10 are disposed close to the timing controller 10, and the second driver chips 22 electrically connected to the first driver chips 21 are disposed away from the timing controller 10. That is, at least a part of the receiving modules of the second driver chips 22 are electrically connected to the timing controller 10, and the distance between each of at least the part of the second driver chips 22 and the timing controller 10 is smaller than the distance between each of the first driver chips 21 and the timing controller 10. As shown in FIG. 1, the second driver chips 22 are arranged at one side of the display panel 30 close to the timing controller 10. The distance between each of these second driver chips 22 and the timing controller 10 is the shortest, and the transmission loss of the display data on the signal line is relatively small. Accordingly, the first driver chips 21 do not need to perform the middle compensation on these second driver chips 22, so the receiving modules of these second driver chips 22 are directly electrically connected to the timing controller 10. The first driver chips 21 only perform the middle compensation on the second driver chips 22 which are is farther away from the timing controller 10. Such an arrangement not only realizes the middle compensation for the display data with large transmission loss, but also ensures that each of the driver chips 20 can accurately receive the display data to improve the display effect. Furthermore, intersections or overlaps of signal lines can be reduced to decrease the interferences of the signal lines, and the display effect can be improved.

In the display device 100 provided by the present disclosure, by arranging the first driver chips 21 closer to the timing controller 10, the first driver chips 21 amplifies the received display data and output the amplified display data to the receiving modules of the second driver chips 22 which are farther away from the timing controller 10. Alternatively, a part of the second driver chips 22 can be arranged at positions closer to the timing controller 10 to be electrically connected to the timing controller 10, so as to reduce the interferences of the intersections or overlaps of the signal lines.

As a specific implementation manner of the present disclosure, please refer to FIG. 4. FIG. 4 illustrates a second schematic structural diagram of each first driver chip in the display device shown in FIG. 1. As shown in FIG. 4, each of the first driver chips 21 includes a receiving module 210, an amplifying module 213, and an output module 214. The receiving module 210 is configured to receive display data, processes the display data, and output a data voltage. The receiving module 210 is further configured to receive the display data, process the display data, and output the processed display data to the amplifying module 213. The amplifying module 213 is configured to amplify the processed display data and output the amplified display data to the output module 214. The output module 214 is configured to process the amplified display data and output the processed amplified display data to a corresponding one of the second driver chips 22. Specifically, the output module 214 is electrically connected to the corresponding one of the second driver chips 22 and is configured to output the processed amplified display data display data to the corresponding one of the second driver chips 22, so that the corresponding one of the second driver chips 22 can accurately receive the display data outputted from the timing controller 10.

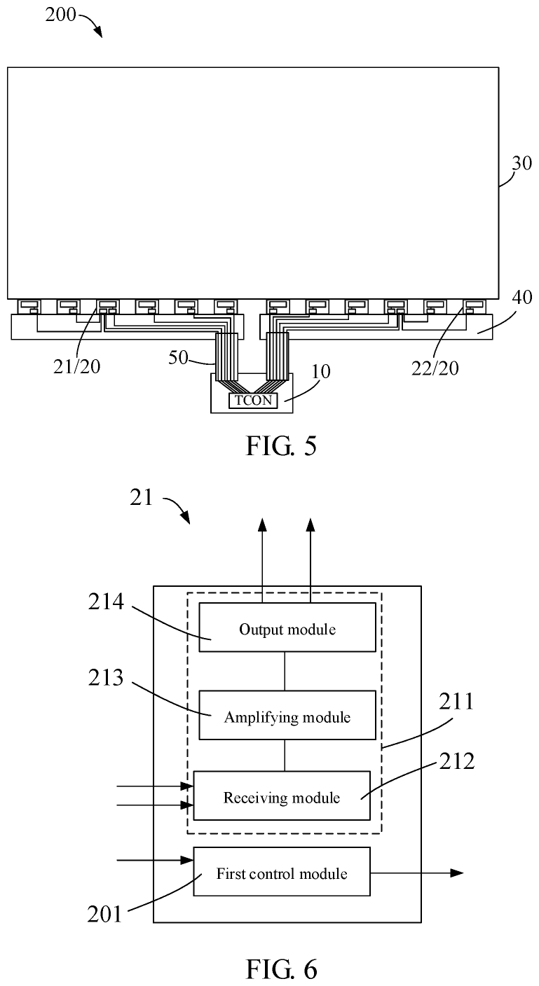

As a specific implementation manner of the present disclosure, please refer to FIG. 5 and FIG. 6. FIG. 5 illustrates a schematic structural diagram of a display device provided by a second embodiment of the present disclosure. FIG. 6 illustrates a schematic structural diagram of each first driver chips in the display device shown in FIG. 5. As shown in FIG. 5 and FIG. 6, the present disclosure provides a display device 200. A difference between the display device 200 and the display device 100 is that at least a part of the first driver chips 21 in the display device 200 are respectively connected to at least two second driver chips 22.

In the embodiment of the present disclosure, the display device 200 includes a timing controller 10 and a plurality of driver chips 20. The timing controller 10 is configured to output display data. The driver chips 20 include a plurality of first driver chips 21 and a plurality of second driver chips 22. At least a part of the second driver chips 22 are electrically connected to the first driver chips 21. Each of the first driver chips 21 is electrically connected to the timing controller 10 and a corresponding one of the second driver chips 22. Each of the first driver chips 21 is configured to convert the display data into amplified display data and transmit the amplified display data to the corresponding one of the second driver chips 22. A voltage potential of the amplified display data is greater than a voltage potential of the display data. That is, intensity/power of the amplified display data is greater than intensity/power of the display data.

In the embodiment of the present disclosure, each of the first driver chips 21 includes a first control module 201 and a second control module 211. The second control module 211 includes a receiving module 212, an amplifying module 213, and an output module 214. The first control module 201 is configured to receive the display data, process the display data, and output the processed display data to the amplifying module 213. The amplifying module 213 is configured to amplify the processed display data and output the amplified display data to the output module 214. The output module 214 is configured to perform an output process on the amplified display data and output the outputted display data to the corresponding one of the second driver chips 22. As shown in FIG. 5, the receiving module 212 is configured to receive the corresponding display data of two of the second driver chips 22. The output module 214 is electrically connected to the two of the second driver chips 22 to output the amplified display data.

In the embodiment of the present disclosure, each of the second driver chips 22 includes a receiving module and a signal processing module. At least a part of the receiving modules of the second driver chips 22 are electrically connected to the output modules 214 of the corresponding first driver chips 21 and configured to receive the amplified display data. Further, the receiving modules of the second driver chips 22 can also be electrically connected to the timing controller 10 to receive the display data outputted by the timing controller 10.

In the embodiment of the present disclosure, the display device 200 further includes a display panel 30. The display panel 30 is electrically connected to the driver chips 20.

In the embodiment of the present disclosure, the display device 200 further includes driving circuit boards 40. The driving circuit boards 40 are provided with input interfaces and output interfaces. The input interfaces are electrically connected to the timing controller 10, and the output interfaces are electrically connected to the driver chip 20.

In the embodiment of the present disclosure, the display device 200 further includes flexible adapter cables 50. The flexible adapter cables 50 are arranged between the timing controller 10 and the driving circuit boards 40. The display data transmitted by the timing controller 10 passes through the flexible adapter cables 50 and the driving circuit boards 40 and then is outputted to the corresponding driver chips 20.

In the display device 200 provided by the present disclosure, a utilization rate of a middle compensation function of the first driver chips 21 is improved by electrically connecting each of the first driver chips 21 to the receiving modules of the at least two of second driver chips 22, and signal interferences of the intersections or overlaps of signal lines are reduced.

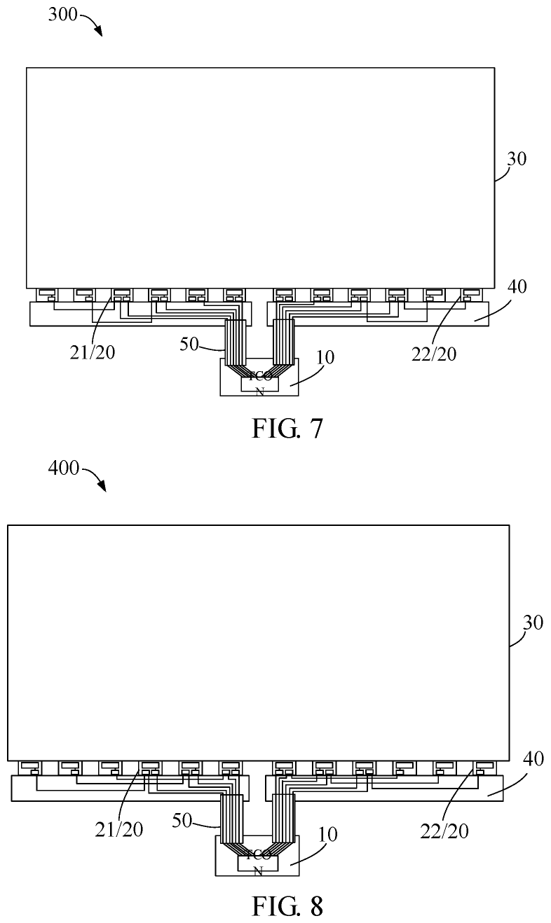

As a specific implementation manner of the present disclosure, please refer to FIG. 7. FIG. 7 illustrates a schematic structural diagram of a display device provided by a third embodiment of the present disclosure. As shown in FIG. 7, the present disclosure provides a display device 300. A difference between the display device 300 and the display device 200 is that in the display device 300, a plurality of first driver chips 21 are arranged close to the timing controller 10, and a plurality of second driver chips 22 are away from the timing controller 10.

In the embodiment of the present disclosure, the display device 300 includes a timing controller 10 and a plurality of driver chips 20. The timing controller 10 is configured to output display data. The driver chips 20 include a plurality of first driver chips 21 and a plurality of second driver chips 22. At least a part of the second driver chips 22 are electrically connected to the first driver chips 21. Each of the first driver chips 21 is electrically connected to the timing controller 10 and a corresponding one of the second driver chips 22. Each of the first driver chips 21 is configured to convert the display data into amplified display data and transmit the amplified display data to the corresponding one of the second driver chips 22. A voltage potential of the amplified display data is greater than a voltage potential of the display data. That is, intensity/power of the amplified display data is greater than intensity/power of the display data.

In the embodiment of present disclosure, each of the first driver chips 21 includes a first control module 201 and a second control module 211. The second control module 211 includes a receiving module 212, an amplifying module 213, and an output module 214. The first control module 201 is configured to receive the display data, process the display data, and output the processed display data to the amplifying module 213. The amplifying module 213 is configured to amplify the processed display data and output the amplified display data to the output module 214. The output module 214 is configured to perform an output process on the amplified display data and output the outputted display data to the corresponding one of the second driver chips 22.

In the embodiment of the present disclosure, each of the second driver chips 22 includes a receiving module and a signal processing module. At least a part of the receiving modules of the second driver chips 22 are electrically connected to the output modules 214 of the corresponding first driver chips 21 and configured to receive the amplified display data. Further, the receiving modules of the second driver chips 22 can also be electrically connected to the timing controller 10 to receive the display data outputted by the timing controller 10.

In the embodiment of the present disclosure, the display device 300 further includes a display panel 30. The display panel 30 is electrically connected to the driver chips 20.

In the embodiment of the present disclosure, the display device 300 further includes driving circuit boards 40. The driving circuit boards 40 are provided with input interfaces and output interfaces. The input interfaces are electrically connected to the timing controller 10, and the output interfaces are electrically connected to the driver chips 20.

In the embodiment of the present disclosure, the display device 300 further includes flexible adapter cables 50. The flexible adapter cables 50 are arranged between the timing controller 10 and the driving circuit boards 40. The display data transmitted by the timing controller 10 passes through the flexible adapter cables 50 and the driving circuit boards 40 and then is outputted to the corresponding driver chips 20.

In the display device 300 provided by the present disclosure, the plurality of first driver chips 21 are arranged close to the timing controller 10, and the plurality of second driver chips 22 are arranged away from the timing controller 10. That is, a distance between each of the first driver chips 21 and the timing controller is smaller than a distance of each of the second driver chips 22 and the timing controller 10, so that loss of the display data received by the receiving modules of the first driver chips 21 is smaller to ensure that the first driver chips 21 accurately receives the display data and perform a middle compensation on the display data transmitted to the second driver chips 22.

As a specific implementation manner of the present disclosure, please refer to FIG. 8. FIG. 8 illustrates a schematic structural diagram of a display device provided by a fourth embodiment of the present disclosure. As shown in FIG. 8, the present disclosure provides a display device 400. A difference between the display device 400 and the display device 300 is that in the display device 400, a number of the first driver chips 21 is equal to a number of the second driver chips 22.

In the embodiment of the present disclosure, the display device 400 includes a timing controller 10 and a driver chip 20. The timing controller 10 is configured to output display data. The driver chips 20 include a plurality of first driver chips 21 and a plurality of second driver chips 22. At least a part of the second driver chips 22 are electrically connected to the first driver chips 21. The first driver chips 21 are electrically connected to the timing controller 10 and a corresponding one of the second driver chips 22. Each of the first driver chips 21 is configured to convert the display data into amplified display data and transmit the amplified display data to the corresponding one of the second driver chips 22. A voltage potential of the amplified display data is greater than a voltage potential of the display data. That is, intensity/power of the amplified display data is greater than intensity/power of the display data.

In the embodiment of the present disclosure, each of the first driver chips 21 includes a first control module 201 and a second control module 211. The second control module 211 includes a receiving module 212, an amplifying module 213, and an output module 214. The first control module 201 is configured to receive the display data, process the display data, and output the processed display data to the amplifying module 213. The amplifying module 213 is configured to amplify the processed display data and output the amplified display data to the output module 214. The output module 214 is configured to perform an output process on the amplified display data and output the output display data to the corresponding one of the second driver chips 22.

In the embodiment of the present disclosure, each of the second driver chips 22 includes a receiving module and a signal processing module. At least a part of the receiving modules of the second driver chips 22 are electrically connected to the output modules 214 of the corresponding first driver chips 21 and configured to receive the amplified display data. Further, the receiving modules of the second driver chips 22 can also be electrically connected to the timing controller 10 to receive the display data outputted by the timing controller 10.

In the embodiment of the present disclosure, the display device 400 further includes a display panel 30. The display panel 30 is electrically connected to the driver chip 20.

In the embodiment of the present disclosure, the display device 400 further includes driving circuit boards 40. The driving circuit boards 40 are provided with input interfaces and output interfaces. The input interfaces are electrically connected to the timing controller 10, and the output interfaces are electrically connected to the driver chips 20.

In the embodiment of the present disclosure, the display device 400 further includes flexible adapter cables 50. The flexible adapter cables 50 are arranged between the timing controller 10 and the driving circuit boards 40. The display data transmitted by the timing controller 10 passes through the flexible adapter cables 50 and the driving circuit boards 40 and then are outputted to the corresponding driver chips 20.

In the display device 400 provided by the present disclosure, the number of the first driver chips 21 is equal to the number of the second driver chips 22, and the first driver chips 21 are electrically connected to the second driver chips 22 in one-to-one correspondence. This is beneficial to ensure that loss of the display data received by the first driver chips 21 is small and perform middle compensation on the display data received by each of the second driver chips 22, thereby improving the transmission loss of the display data outputted by the timing controller 10, increasing the display efficiency, and enhancing the competitiveness of a large-sized display device.

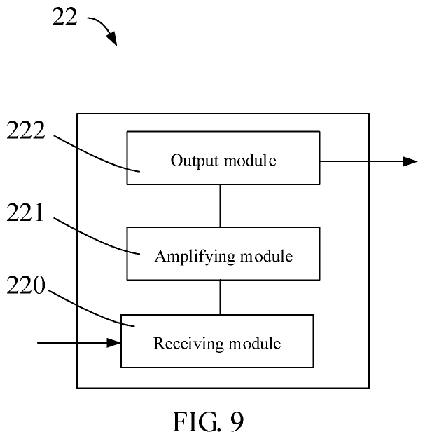

As a specific implementation manner of the present disclosure, please refer to FIG. 9. FIG. 9 illustrates a schematic structural diagram of a second driver chip in the display device provided by an embodiment of the present disclosure. As shown in FIG. 9, the second driver chip 22 includes a receiving module 220, an amplifying module 221, and an output module 222. The receiving module 220 is configured to receive display data, process the display data, and output the processed display data to the amplifying module 221. The amplifying module 221 is configured to amplify the processed display data and output the amplified display data to the output module 222. The output module 222 is configured to perform an output process on the amplified display data and output a data voltage. Specifically, at least one of the second driver chips 22 in the display device is as shown in FIG. 9.

Each of the embodiments of the present disclosure provides a display device. In the display device, the first driver chips 21 are arranged to reduce the loss of the display data transmitted to the second driver chips 22 due to the long transmission lines, thereby improving the display effect.

The display device provided by each of the embodiments of the present disclosure is described above in detail. Although the principles and implementations of the present disclosure are described by using specific examples in this specification, the descriptions of the foregoing embodiments are merely intended to help understand the method and the core idea of the method of the present disclosure. In addition, those skilled in the art can make modifications to the specific implementations and application range according to the idea of the present disclosure. In conclusion, the content of this specification is not construed as a limitation to the present disclosure.

1. A display device, comprising:
a timing controller, wherein the timing controller is configured to output display data; and
a plurality of driver chips, wherein the driver chips comprise a plurality of first driver chips and a plurality of second driver chips, and at least a part of the second driver chips are electrically connected to the first driver chips;
wherein each of the first driver chips is electrically connected to the timing controller and a corresponding one of the second driver chip, each of the first driver chips is configured to receive the display data, amplify the display data, and transmit the amplified display data to the corresponding one of the second driver chips;
wherein each of the first driver chips comprises a receiving module, and the receiving module of each of the first driver chips is configured to receive the display data; and
wherein at least one of the second driver chips comprises a receiving module, and the receiving module of the at least one of the second driver chips is configured to receive display data from a corresponding one of the first driver chips and the timing controller.

2. The display device of claim 1, wherein the first driver chips are further configured to receive the display data, process the display data, and output data voltages.

3. The display device of claim 2, wherein each of the first driver chips comprises a first control module and a second control module; and
the first control module is configured to receive the display data, process the display data, and output the data voltage to the second control module.

4. The display device of claim 3, wherein the second control module further comprises an amplifying module; the receiving module is further configured to process the display data and output the processed display data to the amplifying module; and
the amplifying module is configured to amplify the processed display data and output the amplified display data to the output module.

5. The display device of claim 4, wherein the second control module further comprises an output module;
the output module is configured to perform an output process on the amplified display data and output the outputted display data to the corresponding one of the second driver chips.

6. (canceled)

7. The display device of claim 1, wherein each of the first driver chips is electrically connected to one of the second driver chips.

8. The display device of claim 1, when at least a part of the first driver chips are respectively electrically connected to at least two of the second driver chips.

9. The display device of claim 1, wherein at least a part of the second driver chip are electrically connected to the timing controller, the second driver chips electrically connected to the timing controller are disposed close to the timing controller, and the second driver chips electrically connected to the first driver chips are disposed away from the timing controller.

10. The display device of claim 1, wherein multiple of the first driver chips are arranged close to the timing controller, and multiple of the second driver chips are arranged away from the timing controller.

11. The display device of claim 1, wherein a number of the first driver chips is equal to a number of the second driver chips.

12. The display device of claim 1, wherein the at least one of the second driver chips further comprises an amplifying module and an output module;
the receiving module is configured to process the display data and output the processed display data to the amplifying module;
the amplifying module is configured to amplify the processed display data and output the amplified display data to the output module; and
the output module is configured to perform an output process on the amplified display data and output a data voltage.

13. A display device, comprising:
a timing controller, wherein the timing controller is configured to output display data;
a plurality of driver chips, wherein the driver chips comprise a plurality of first driver chips and a plurality of second driver chips, and at least a part of the second driver chips are electrically connected to the first driver chips; and
at least two driving circuit boards, wherein the at least two driving circuit boards are connected between the timing controller and the driver chips, and the driver chips are sequentially arranged along a length direction of the driving circuit boards;
wherein each of the first driver chips is electrically connected to the timing controller and a corresponding one of the second driver chip, each of the first driver chips is configured to receive the display data, amplify the display data, and transmit the amplified display data to the corresponding one of the second driver chips;
wherein each of the first driver chips comprises a receiving module, and the receiving module of each of the first driver chips is configured to receive the display data; and
wherein at least one of the second driver chips comprises a receiving module, and the receiving module of the at least one of the second driver chips is configured to receive display data from a corresponding one of the first driver chips and the timing controller
